(19) United States
(12) Patent Application Publication
(10) Pub. No.: US 2024/0186744 A1
(43) Pub. Date: Jun. 6, 2024

(54) CONNECTOR HOUSING ASSEMBLY, CONNECTOR AND CHARGING SEAT ASSEMBLY

(71) Applicants: Tyco Electronics (SIP) Ltd., Suzhou (CN); Tyco Electronics (Shanghai) Co., Ltd., Shanghai (CN)

(72) Inventors: Qun (Sunny) Zhang, Suzhou (CN); Ming Xu, Suzhou (CN); Fangyue (Jason) Zhu, Shanghai (CN)

(73) Assignees: Tyco Electronics (SIP) Ltd., Suzhou (CN); Tyco Electronics (Shanghai) Co., Ltd., Shanghai (CN)

(21) Appl. No.: 18/524,780

(22) Filed: Nov. 30, 2023

(30) Foreign Application Priority Data
Dec. 2, 2022 (CN) 202223227821.8

(51) Int. Cl. H01R 13/52; H01R 13/516

(52) U.S. Cl. CPC H01R 13/5202; H01R 13/516

(57) ABSTRACT

A connector housing assembly comprises a housing, an end cover, and a sealing ring. The housing is adapted to receive a metal bar and includes a terminal hole adapted to receive one end of a charging terminal of a charging seat. The end cover is detachably fixed to the housing and defines a terminal through hole receiving the one end of the charging terminal therethrough. The sealing ring is compressed between the housing and the end cover and surrounds the terminal hole and the terminal through hole.

### CROSS-REFERENCE TO RELATED APPLICATION

This application claims the benefit of Chinese Patent Application No. CN202223227821.8 filed on Dec. 2, 2022, in the State Intellectual Property Office of China, the whole disclosure of which is incorporated herein by reference.

### FIELD OF THE INVENTION

The invention relates to a connector housing assembly, a connector comprising the connector housing assembly and a charging seat assembly including the connector.

### BACKGROUND

In charging assemblies of the prior art, a copper wire is usually electrically connected to a charging terminal of a charging seat. In order to connect the wire to the terminal, a connecting terminal is typically connected at one end of the wire and fastened to one end of the charging terminal with a bolt. The connection operation associated with this arrangement, however, is very inconvenient, time-consuming, and labor-intensive. Moreover, assembly of the copper wire and the housing of the charging seat is relatively complex, making it difficult to achieve automated production and requiring manual operation, greatly reducing production efficiency. In addition, in the prior art, as one end of the copper wire is inserted into the housing of the charging seat, if the copper wire requires replacement, the housing of the charging seat must be disassembled first before the wire can be removed from the charging terminal. This makes subsequent maintenance operations difficult.

### SUMMARY

According to an embodiment of the present disclosure, a connector housing assembly comprises a housing, an end cover, and a sealing ring. The housing is adapted to receive a metal bar and includes a terminal hole adapted to receive one end of a charging terminal of a charging seat. The end cover is detachably fixed to the housing and defines a terminal through hole receiving the one end of the charging terminal therethrough. The sealing ring is compressed between the housing and the end cover and surrounds the terminal hole and the terminal through hole.

### BRIEF DESCRIPTION OF THE DRAWINGS

The invention will now be described by way of example with reference to the accompanying Figures, of which:

FIG. 1 is an illustrative perspective view of a connector according to an exemplary embodiment of the invention, wherein the housing and end cover are fixed together;

FIG. 2 is an illustrative perspective view of a connector according to an exemplary embodiment of the invention, wherein the housing and end cover are not yet fixed together;

FIG. 3 is a cross-sectional view of a connector according to an exemplary embodiment of the invention;

FIG. 4 is an illustrative exploded view of a connector according to an exemplary embodiment of the invention;

FIG. 5 is an illustrative perspective view of the end cover and sealing ring of a connector according to an exemplary embodiment of the invention;

FIG. 6 is an illustrative view of a metal bar connected to a charging terminal according to an exemplary embodiment of the invention;

FIG. 7 is a spatial arrangement view of metal bars according to an exemplary embodiment of the invention; and

FIG. 8 is a top view of metal bars according to an exemplary embodiment of the invention.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

A connector housing assembly according to embodiments of the present disclosure comprises a housing, an end cover detachably fixed to the housing, and a sealing ring. The housing is adapted to receive a conductive element or metal bar and is formed with a terminal hole into which one end of a charging terminal of a charging seat to be inserted. The end cover is formed with a terminal through hole to allow the one end of the charging terminal to pass through. The sealing ring is compressed between the housing and the end cover to achieve sealing between the two. The sealing ring surrounds the terminal hole and the terminal through hole, so that the terminal hole and terminal through hole are surrounded inside the sealing ring.

According to another embodiment of the present disclosure, a connector comprises the above connector housing, a conductive element or metal bar inserted into the housing, and a connecting member provided in the housing. The connecting member connects the metal bar to one end of a charging terminal inserted into the housing.

A charging seat assembly according to another embodiment includes the above connector and a charging seat. The charging seat comprises a charging seat housing, and a charging terminal arranged in the charging seat housing. The end cover of the connector is installed on an end of the charging seat housing. One end of the charging terminal passes through the end cover and is inserted into the housing of the connector to electrically connect with the metal bar inserted into the housing.

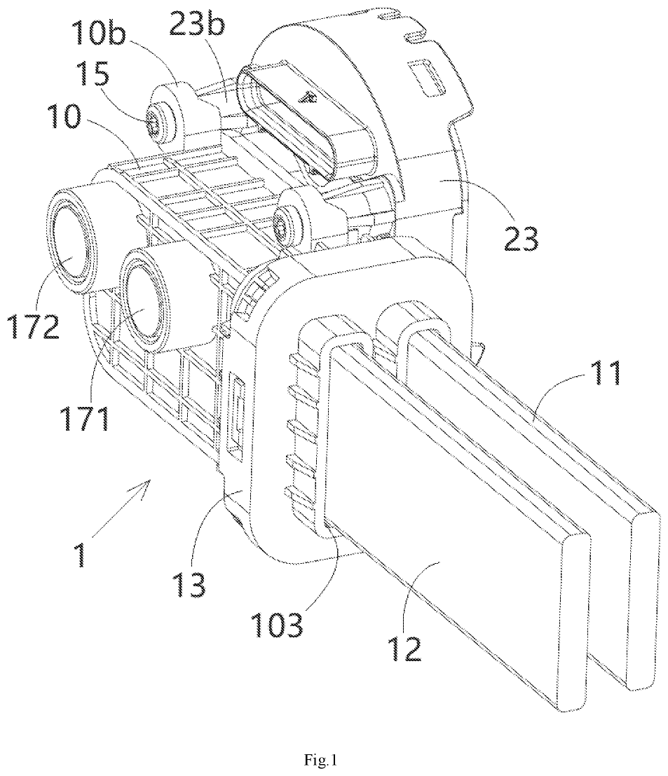

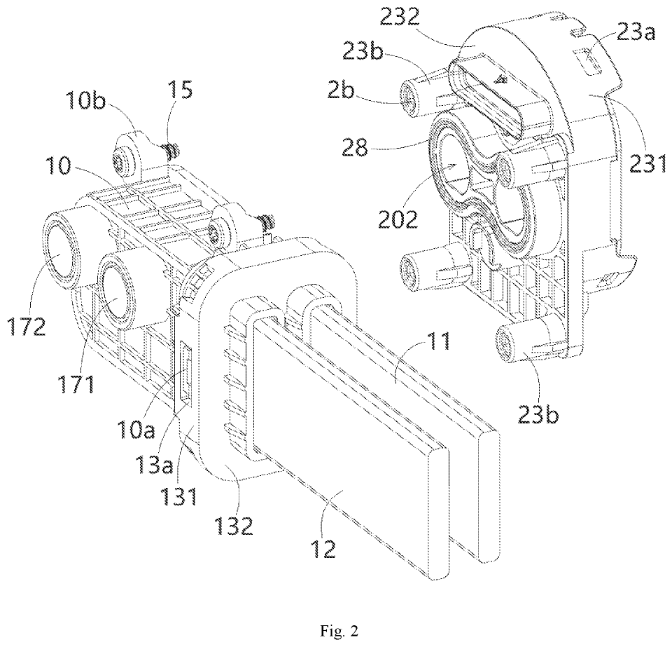

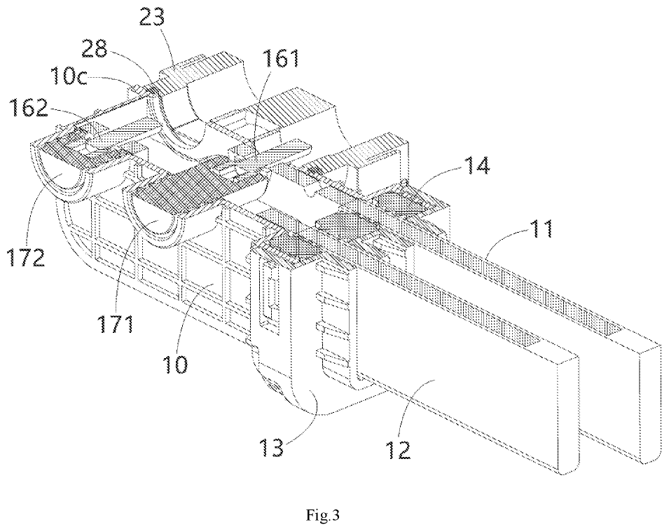

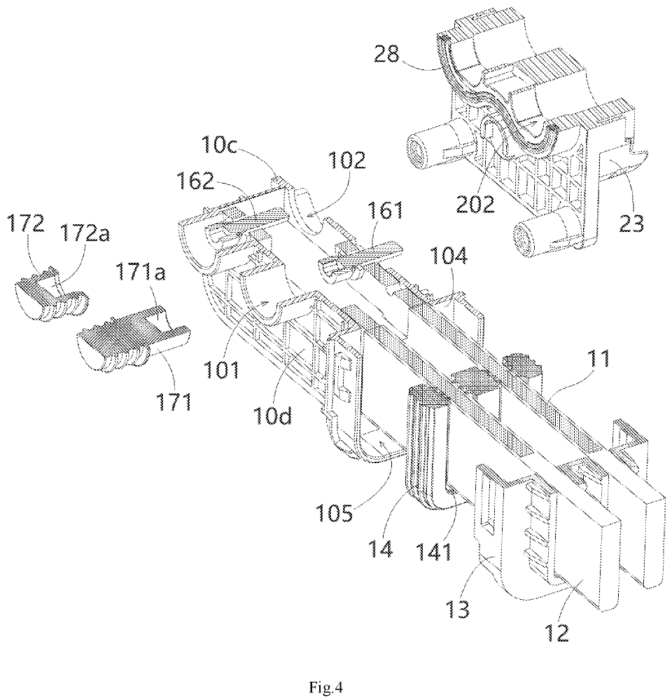

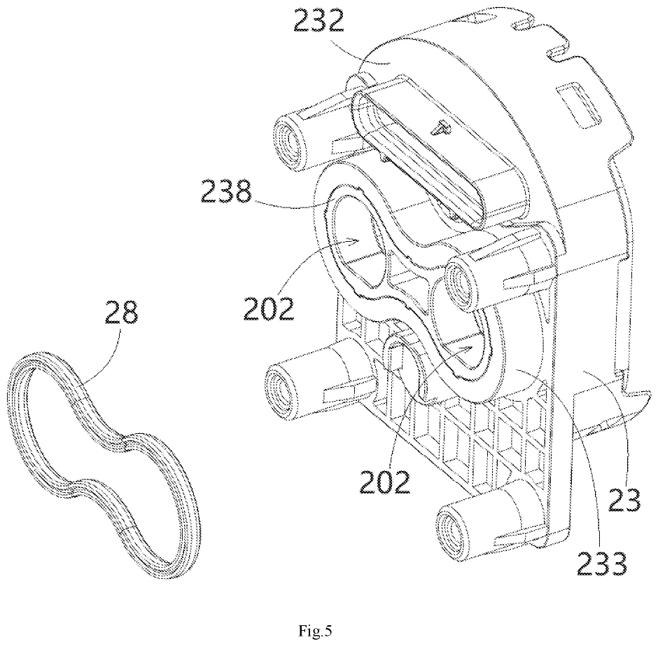

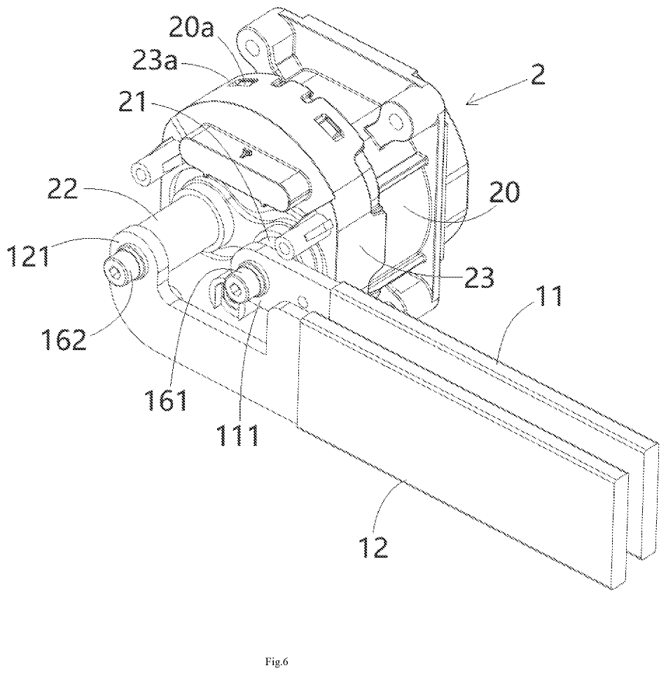

FIG. 1 is an illustrative perspective view of a connector 1 according to an exemplary embodiment of the invention, wherein a housing 10 and an end cover 23 are fixed together. FIG. 2 is an illustrative perspective view of connector 1 according to an exemplary embodiment of the invention, wherein the housing 10 and end cover 23 are not yet fixed together. FIG. 3 is a cross-sectional view of connector 1 according to an exemplary embodiment of the invention. FIG. 4 is an illustrative exploded view of a connector 1 according to an exemplary embodiment of the invention. FIG. 5 is an illustrative perspective view of the end cover 23 and a sealing ring 28 of the connector 1 according to an exemplary embodiment of the invention. FIG. 6 is an illustrative view of a metal bar connected to a charging terminal according to an exemplary embodiment of the invention.

As shown in FIGS. 1-6, in an exemplary embodiment of the invention, a connector housing assembly is disclosed. The connector housing assembly includes the housing 10, the end cover 23, and the sealing ring 28. The housing 10 is used for inserting a conductive element or metal bar 11, 12 and formed with a terminal hole 102 that allows one end of a charging terminal 21, 22 of a charging seat to be inserted. The end cover 23 is detachably fixed to the housing 10 and formed with a terminal through hole 202 that allows one end of the charging terminal 21, 22 to pass through. The sealing ring 28 is compressed between the housing 10 and the end cover 23 to achieve sealing between the two. In the illustrated embodiment, the sealing ring 28 surrounds the terminal hole 102 and the terminal through hole 202, so that the terminal hole 102 and the terminal through hole 202 are surrounded inside the sealing ring 28. In this way, it can effectively prevent water vapor from entering the housing 10 of connector 1 and the charging seat housing 20 through the terminal hole 102 and the terminal through hole 202.

A sealing ring installation groove 238 can be formed on one of the housing 10 and the end cover 23. The sealing ring 28 is installed in the sealing ring installation groove 238. In the illustrated embodiment, the sealing ring installation groove 238 is formed on the end wall 232 of the end cover 23. In the illustrated embodiment, the sealing ring 28 and the sealing ring installation groove 238 are in an 8-shaped shape.

The housing 10 has a front end and a rear end that are opposite in its longitudinal direction, and a rear port 105 is formed at the rear end of the housing 10. The connector housing assembly also includes an elastic seal 14. The elastic seal 14 is installed in the rear port 105 of the housing 10 and formed with a metal bar through hole 141 that allows the metal bar 11, 12 to pass through. The elastic seal 14 is compressed between the housing 10 and the metal bar 11, 12 to achieve sealing between the two.

The connector housing assembly further includes a rear cover 13. The rear cover 13 is installed on the rear end of the housing 10 and formed with a metal bar hole or opening 103 that allows the metal bar 11, 12 to be inserted into the housing 10. A positioning step 104 is formed in the rear port 105 of the housing 10. The positioning step 104 and the rear cover 13 are respectively pressed against the two ends of the elastic seal 14 to maintain the elastic seal 14 in the rear port 105 of the housing 10.

In the illustrated embodiments, the rear cover 13 includes a peripheral wall 131 and an end wall 132 connected to the peripheral wall 131. The metal bar hole 103 is formed in the end wall 132 of the rear cover 13. A snapping slot 13a is formed on the peripheral wall 131 of the rear cover 13, and a protrusion 10a is formed on the outside of the rear end of the housing 10. The protrusion 10a is engaged into the snapping slot 13a to fix the rear cover 13 to the rear end of the housing 10.

The housing 10 has a bottom wall 10c and a top wall 10d opposite to each other in its height direction, and the terminal hole 102 is formed in the bottom wall 10c of the housing 10. The end cover 23 has an end wall 232 opposite to the bottom wall 10c of the housing 10, and a terminal through hole 202 is formed in the end wall 232 of the end cover 23. The sealing ring 28 is compressed between the bottom wall 10c of the housing 10 and the end wall 232 of the end cover 23 to achieve sealing between the two.

A boss 233 is formed on the end wall 232 of the end cover 23, and the terminal through hole 202 passes through the boss 233. The sealing ring 28 is compressed between the bottom wall 10c of the housing 10 and the boss 233 of the end cover 23 to achieve sealing between the two. A sealing ring installation groove 238 is formed on the top surface of the boss 233 of the end cover 23. The sealing ring 28 is installed in the sealing ring installation groove 238.

An installation hole 101 is formed in the top wall 10d of the housing 10. The installation hole 101 enables the connecting member 161, 162 used to connect the metal bar 11, 12 and the charging terminal 21, 22 to enter the housing 10 through the installation hole 101. The connector housing assembly also includes a sealing plug 171, 172, which is inserted into the installation hole 101 to seal the installation hole 101.

Multiple connecting ears 10b are formed on the side wall of the housing 10, and multiple connecting posts 23b are formed on the end wall 232 of the end cover 23. The connector housing assembly also includes multiple connecting screws 15, which connect multiple connecting ears 10b to multiple connecting posts 23b to fix the housing 10 and the end cover 23 together. In the illustrated embodiment, the connecting screw 15 passes through the connecting ear 10b and is connected to a blind hole 2b formed in the connecting post 23b. The end cover 23 also has a peripheral wall 231 connected to the end wall 232, and a slot hole 23a is formed on the peripheral wall 231 suitable for engaging with a protrusion 20a on the charging seat housing 20, for fixing the end cover 23 to an end of the charging seat housing 20.

In another exemplary embodiment of the invention, the connector 1 is adapted to electrically connecting to a charging seat 2. The connector 1 includes the aforementioned connector housing assembly, the metal bar 11, 12 and the connecting member 161, 162. The metal bar 11, 12 is inserted into the housing 10. The connecting member 161, 162 is provided in the housing 10. The connecting member 161, 162 connects the metal bar 11, 12 to the one end of the charging terminal 21, 22 inserted into the housing 10.

The connecting member 161, 162 enters the housing 10 through the installation hole 101 of the housing 10, and the installation hole 101 is sealed by the inserted sealing plug 171, 172. On one end of the sealing plug 171, 172, there is a receiving recess 171a, 172a formed, and the head of one end of the connecting member 161, 162 is accommodated in the receiving recess 171a, 172a. In the illustrated embodiment, the connecting member 161, 162 can be, but are not limited to, a bolt, the head of which is accommodated in the receiving recess 171a, 172a on the sealing plug 171, 172. This not only prevents human fingers from touching the head of connecting member 161, 162, but also increases the creepage distance between two adjacent connecting members 161 and 162, improving the electrical insulation performance of the product.

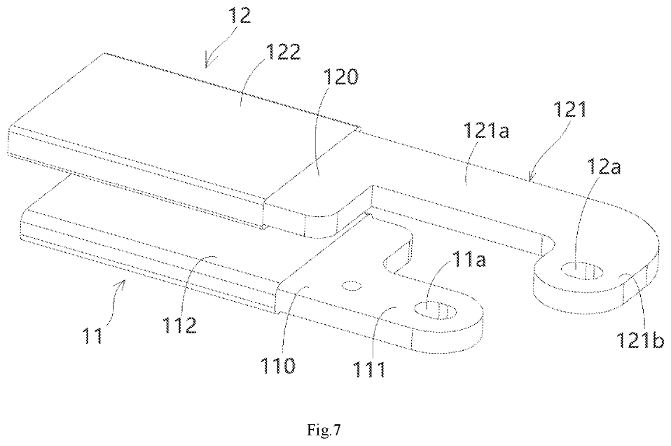

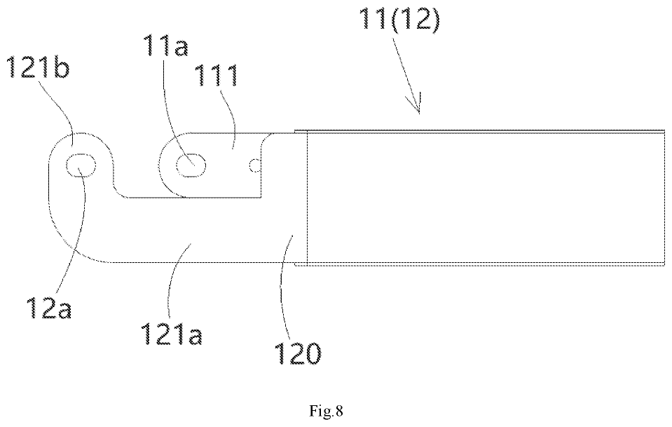

FIG. 7 shows a spatial arrangement view of the metal bars 11, 12 according to an exemplary embodiment of the invention. FIG. 8 shows a top view of metal bars 11, 12 according to an exemplary embodiment of the invention. As shown in FIGS. 1 to 8, the metal bar 11, 12 includes a first metal bar 11 and a second metal bar 12. The first metal bar 11 is flat and used for electrical connection with a first charging terminal 21 of the charging seat 2. The second metal bar 12 is flat and used for electrical connection with a second charging terminal 22 of the charging seat 2. In the illustrated embodiment, the first metal bar 11 and the second metal bar 12 have the same width and have left and right sides opposite to each other in the width direction thereof. When the first and second metal bars 11 and 12 are respectively connected to the first and second charging terminals 21 and 22, the first metal bar 11 and the second metal bar 12 overlap each other in their thickness direction, so that the left and right sides of the first metal bar 11 are respectively flush with the left and right sides of the second metal bar 12.

A first connection hole 11a and a second connection hole 12a are formed in the first metal bar 11 and the second metal bar 12, respectively. The connecting member 161, 162 includes a first connecting member 161 and a second connecting member 162 that pass through the first connection hole 11a and the second connection hole 12a, respectively. The first connecting member 161 and the second connecting member 162 are used to connect the first metal bar 11 and the second metal bar 12 to the first charging terminal 21 and the second charging terminal 22, respectively.

The dimension of the first connection hole 11a and the second connection hole 12a in the length direction of the metal bar 11, 12 is greater than that in the width direction of the metal bar 11, 12, allowing the first connecting member 161 and the second connecting member 162 to move along the length direction of the a metal bar 11, 12 in the first connection hole 11a and the second connection hole 12a, respectively. In this way, the position error between a metal bar 11, 12 and the charging terminal 21, 22 can be absorbed, making the installation and operation of the metal bar 11, 12 easier and more convenient.

Two installation holes 101 are formed in the top wall 10d of the housing 10. The sealing plug 171, 172 includes a first sealing plug 171 and a second sealing plug 172 inserted into the two installation holes 101, respectively. In the illustrated embodiment, the structure of the first sealing plug 171 and the second sealing plug 172 are basically the same, except for different axial lengths.

The first metal bar 11 includes a flat first metal conductor 110 and a first insulator 112 wrapped on the first metal conductor 110. The first metal conductor 110 has a first connection end 111 exposed out of the first insulator 112 for electrical connection to the first charging terminal 21, and the first connection hole 11a is formed in the first connection end 111. The second metal bar 12 includes a flat second metal conductor 120 and a second insulator 122 wrapped on the second metal conductor 120. The second metal conductor 120 has a second connection end 121 exposed out of the second insulator 122 for electrical connection to the second charging terminal 22, and the second connection hole 12a is formed in the second connection end 121.

The first connection end 111 is spatially avoided or separated from the second connection end 121, so that the first connection hole 11a of the first connection end 111 is not obstructed by the second connection end 121. Therefore, the first connecting member 161 can be inserted unobstructed into the first connection hole 11a of the first connection end 111. The first connection end 111 extends along the length direction of the metal bar 11, 12, and the width of the first connection end 111 is not more than half of the width of the metal bar 11, 12, and is offset to one side of the width direction of the metal bar 11, 12. The second connection end 121 is L-shaped, including a first extension portion 121a extending along the length direction of the metal bar 11, 12 and a second extension portion 121b extending along the width direction of the metal bar 11, 12. The first extension portion 121a extends along the length direction of the metal bar 11, 12 beyond the first connection end 111, and the width of the first extension portion 121a is not more than half of the width of a metal bar 11, 12, and is offset to the other side of the width direction of the metal bar 11, 12. Therefore, the first connection end 111 and the second connection end 121 are spatially staggered from each other to ensure that there is no problem of mutual obstruction between the two. In the illustrated embodiments, the aforementioned metal bar 11, 12 can be an aluminum bar or any other suitable metal bar.

In another exemplary embodiment of the invention, a charging seat assembly is also disclosed. The charging seat assembly includes the connector 1 and the charging seat 2. The charging seat 2 includes the charging seat housing 20 and the charging terminal 21, 22. The charging terminal 21, 22 is arranged in the charging seat housing 20. The end cover 23 of connector 1 is installed on an end of the charging seat housing 20. One end of charging terminal 21, 22 passes through the end cover 23 and is inserted into the housing 10 of connector 1 to electrically connect with the metal bar 11, 12 inserted into the housing 10. In an exemplary embodiment of the invention, the charging seat 2 also includes a first sealing ring, which is compressed between the end cover 23 and the charging seat housing 20 to achieve sealing between the two. This can prevent water vapor from entering the charging seat housing 20 through the gap between the end cover 23 and the charging seat housing 20.

In an exemplary embodiment of the invention, a terminal installation hole for installing the charging terminal 21, 22 is formed in the charging seat housing 20. The charging seat 2 also includes a second sealing ring, which is compressed between the charging terminal 21, 22 and the hole wall of the terminal installation hole to achieve sealing between the two. This can prevent water vapor from entering the charging seat housing 20 through the gap between the charging terminal 21, 22 and the hole wall of the terminal installation hole.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector housing assembly, comprising:
a housing adapted to receive a metal bar and including a terminal hole adapted to receive one end of a charging terminal of a charging seat;
an end cover detachably fixed to the housing and defining a terminal through hole receiving the one end of the charging terminal therethrough; and
a sealing ring compressed between the housing and the end cover and surrounding the terminal hole and the terminal through hole.

2. The connector housing assembly according to claim 1, wherein a sealing ring installation groove is formed on one of the housing or the end cover and receives the sealing ring.

3. The connector housing assembly according to claim 1, wherein the housing includes:
a front end and a rear end that are opposite in a longitudinal direction; and
a rear port formed at the rear end of the housing.

4. The connector housing assembly according to claim 3, further comprising an elastic seal arranged in the rear port of the housing and formed with a metal bar through hole adapted to receive the metal bar therethrough, the elastic seal is adapted to be compressed between the housing and the metal bar to achieve sealing between the two.

5. The connector housing assembly according to claim 4, further comprising a rear cover arranged on the rear end of the housing and formed with a metal bar hole adapted to receive the metal bar.

6. The connector housing assembly according to claim 5, wherein a positioning step is formed in the rear port of the housing, and the positioning step and the rear cover respectively abut against two ends of the elastic seal.

7. The connector housing assembly according to claim 5, wherein:
the rear cover includes a peripheral wall and an end wall connected to the peripheral wall, and the metal bar hole is formed in the end wall of the rear cover; and
a snapping slot is formed on the peripheral wall of the rear cover, and a protrusion is formed on the outside of the rear end of the housing, the protrusion is engaged into the snapping slot and fixes the rear cover to the rear end of the housing.

8. The connector housing assembly according to claim 1, wherein:
the housing has a bottom wall and a top wall opposite to each other in a height direction, the terminal hole is formed in the bottom wall of the housing;
the end cover has an end wall opposite the bottom wall of the housing, a boss is formed on the end wall and the terminal through hole passes through the boss; and
the sealing ring is compressed between the bottom wall of the housing and the boss of the end cover.

9. The connector housing assembly according to claim 8, wherein a sealing ring installation groove is formed on a top surface of the boss of the end cover, and the sealing ring is installed in the sealing ring installation groove.

10. The connector housing assembly according to claim 8, further comprising a sealing plug, wherein an installation hole is formed in the top wall of the housing and the sealing plug is inserted into the installation hole.

11. The connector housing assembly according to claim 8, further comprising a plurality of connecting screws, wherein multiple connecting ears are formed on a side wall of the housing, and multiple connecting posts are formed on the end wall of the end cover, and the plurality of connecting screws connect to respective ones of the multiple connecting ears to the multiple connecting posts and fix the housing and the end cover together.

12. The connector housing assembly according to claim 8, wherein the end cover further includes a peripheral wall connected to the end wall, a slot hole is formed on the peripheral wall and engaging with a protrusion on a charging seat housing.

13. A connector, comprising:
a connector housing assembly, including:
a housing adapted to receive a metal bar and including a terminal hole adapted to receive one end of a charging terminal of a charging seat;
an end cover detachably fixed to the housing and defining a terminal through hole receiving the one end of the charging terminal therethrough; and
a sealing ring compressed between the housing and the end cover and surrounding the terminal hole and the terminal through hole;
a metal bar inserted into the housing; and
a connecting member arranged in the housing and connecting the metal bar to one end of a charging terminal inserted into the housing.

14. The connector according to claim 13, wherein:
the connecting member enters the housing through an installation hole of the housing, the installation hole is sealed by a sealing plug inserted into the installation hole; and
a receiving recess is formed on one end of the sealing plug and receives a head of one end of the connecting member.

15. The connector according to claim 14, wherein:
the metal bar includes:
a first metal bar is flat in shape and is adapted to electrically connect with a first charging terminal of a charging seat; and
a second metal bar is flat in shape and is adapted to electrically connect with a second charging terminal of the charging seat;
the first metal bar and the second metal bar have the same width and have left and right sides opposite to each other in a width direction thereof; and
when the first and second metal bars are connected to respective ones of the first and second charging terminals, the first metal bar and the second metal bar overlap each other in a thickness direction thereof.

16. The connector according to claim 14, wherein the metal bar is an aluminum bar.

17. A charging seat assembly, comprising:
a connector, including:
a connector housing assembly, having:
a housing adapted to receive a metapl bar and including a terminal hole adapted to receive one end of a charging terminal of a charging seat;
an end cover detachably fixed to the housing and defining a terminal through hole receiving the one end of the charging terminal therethrough; and
a sealing ring compressed between the housing and the end cover and surrounding the terminal hole and the terminal through hole;
a metal bar inserted into the housing; and
a connecting member arranged in the housing and connecting the metal bar to one end of a charging terminal inserted into the housing; and
a charging seat, including:
a charging seat housing; and
a charging terminal arranged in the charging seat housing, the end cover of the connector is arranged on an end of the charging seat housing, and one end of the charging terminal passes through the end cover and is inserted into the housing of the connector to electrically connect with the metal bar inserted into the housing.

18. The charging seat assembly according to claim 17, wherein the charging seat further includes a first sealing ring compressed between the end cover and the charging seat housing to achieve sealing between the two.

19. The charging seat assembly according to claim 18, wherein a terminal installation hole is formed in the charging seat housing.

20. The charging seat assembly according to claim 19, wherein the charging seat further includes a second sealing ring compressed between the charging terminal and a hole wall of the terminal installation hole.
